(19) United States
(12) Patent Application Publication
(10) Pub. No.: US 2020/0165509 A1
(43) Pub. Date: May 28, 2020

(54) METHODS FOR DIAGNOSING, MONITORING AND MITIGATING MICROBIOLOGICALLY INFLUENCED CORROSION

(71) Applicant: ExxonMobil Research and Engineering Company, Annandale, NJ (US)

(72) Inventors: Xiaozhou Zhang, Bridgewater, NJ (US); Dennis R. Enning, Spring, TX (US); Meytal B. Higgins, Princeton, NJ (US); Jaspreet Mand, Houston, TX (US); Fang Cao, Basking Ridge, NJ (US); Giovanni Pilloni, Jersey City, NJ (US); Mohor Chatterjee, Annandale, NJ (US)

(21) Appl. No.: 16/672,152

(22) Filed: Nov. 1, 2019

Related U.S. Application Data
(60) Provisional application No. 62/772,119, filed on Nov. 28, 2018.

(51) Int. Cl. C09K 8/54; C09K 8/536

(52) U.S. Cl. CPC C09K 8/54; C09K 2208/32; C09K 8/536

(57) ABSTRACT

Provided are methods for diagnosing, monitoring and mitigating microbiologically influenced corrosion (MIC). The methods employ steps to determine the nature and concentration of biological signatures, formed through metabolism of microorganisms, and correlating the biological signatures with MIC. Based on such analyses, appropriate MIC mitigation strategies may be implemented so as to efficiently target MIC at sites of interest. The methods advantageously allow selection of appropriate MIC mitigation treatments that correspond to the level of severity of the MIC and based on historical data correlating particular biological signatures with particular MIC risk.

### CROSS-REFERENCE TO RELATED APPLICATIONS

This application claims priority to U.S. Provisional Application No. 62/772,119 filed Nov. 28, 2018, the entirety of which is herein incorporated by reference in its entirety.

### FIELD

This disclosure generally relates to improved methods for diagnosing, monitoring and mitigating microbiologically influenced corrosion (‘MIC’) of solid surfaces, such as the equipment used by the petroleum and natural gas industries to store, transport, and process raw materials such as oil and gas. More specifically, the disclosure relates to methods for monitoring the severity of MIC based on correlating the nature and amount of biological signatures associated with active MIC. Accordingly, the disclosure further relates to methods for MIC mitigation that involve the assessment and monitoring of various biological signatures as indicators of active MIC coupled with treatment programs that match the MIC activity identified.

### BACKGROUND

Microbiologically influenced corrosion (‘MIC’) is increasingly recognized as a considerable threat to asset integrity in the petroleum and natural gas industry. Approximately 20% of the total cost of corrosion in upstream and midstream operations is estimated to be associated with MIC. Failures and pre-emptive replacement of many pipelines have repeatedly been linked to corrosion caused by microorganisms.

The mechanisms by which MIC causes damage are poorly understood despite many years of research. See Kwan Li et al., Beating the bugs: Roles of microbial biofilms in corrosion, Corrosion Reviews, Vol. 31, Issue 3-6, December 2013, pp. 73-84. However, it is believed that MIC is primarily caused by the formation of microbial biofilms on metal surfaces that are contacted with produced water associated with crude oil and gas and/or the liquid systems involved in their refinery.

These biofilms may consume the metal either directly or through the effect of corrosive metabolic by-products (e.g., hydrogen sulfide and/or carbonic acid). Although vast amounts of academic knowledge and industrial experience exist, an effective and economic approach to diagnose and monitor MIC is still lacking. See Kannan at al., A Review of Characterization and Quantification Tools for Microbiologically Influenced Corrosion in the Oil and Gas Industry; Current and Future Trends, Ind. Eng. Chem. Res, 2018, 57, 42, pp. 13895-13922. Current MIC monitoring and diagnosis techniques (e.g. counting the total number of living cells, detection of sulfate-reducing bacteria (SRB), and microbial community analysis) are expensive, slow, and highly uncertain. False conclusions may result from the use of these techniques since the presence of broad groups of bacteria does not necessarily mean that corrosion-inducing metabolism is occurring, and the correlation between the presence of bacteria and corrosion remains poorly understood and may be system-specific or, in some cases, non-existent.

The microorganisms thought to be primarily responsible for corrosion at least in an anaerobic environment within the oil industry are sulfate-reducing bacteria. Other culpable bacteria include iron oxidizing bacteria, sulfur oxidizing bacteria, nitrate reducing bacteria, methanogens, and acid producing bacteria, among others. These categories of bacteria are generally capable of oxidizing metal directly, producing metabolic products that are corrosive (e.g., hydrogen sulfide gas), and/or leading to the formation of biofilms that otherwise alter the local environment thereby accelerating corrosion. See Jack, T. R. (2002) Biological corrosion failures, in ASM Handbook Volume 11: Failure Analysis and Prevention. Shipley, R. J., and Becker, W. T. (eds), Materials Park, Ohio, USA: ASM International, pp. 881-898 and Enning and Garrelfs (2014) Corrosion of iron by sulfate-reducing bacteria—New views of an old problem, Applied and Environmental Microbiology, Volume 80, pp. 1226-1236.

Sulfate-reducing bacteria (SRB), are ubiquitous and can grow in almost any environment. They may be found in waters associated with oil production systems and can be found in virtually all industrial aqueous processes, including cooling water systems and petroleum refining. Sulfate-reducing bacteria require an anaerobic (oxygen-free) aqueous solution containing adequate nutrients, an electron donor, and electron acceptor. A typical electron acceptor is sulfate, which produces hydrogen sulfide upon reduction. Hydrogen sulfide is a highly corrosive gas and reacts with metal surfaces to form insoluble iron sulfide corrosion products. In addition, hydrogen sulfide partitions into the water, oil, and natural gas phases of produced fluids and creates a number of serious problems. For instance, ‘sour’ oil and gas, which contains high levels of hydrogen sulfide, have a lower commercial value than low sulfide oil and gas. Removing biogenic hydrogen sulfide from sour oil and gas increases the cost of these products.

Corrosion caused by sulfate-reducing bacteria or other environmental microorganisms frequently results in extensive damage to oil and gas storage, production, and transportation equipment. Pipe systems, tank bottoms, and other pieces of oil production equipment can rapidly fail if there are areas where MIC is occurring.

Many methods are listed in the National Association of Corrosion Engineers (NACE) standards for MIC testing (e.g. TM0212-2018), including microbiological culture testing, light microscopy, epifluorescent microscopy, adenosine triphosphate photometry, hydrogenase measurements, detection of adenosine phosphosulfate reductase from active SRB using antibodies, chemical analysis for corrosion products, and Molecular Microbiological Methods (MMMs) based on DNA analysis for the detection of microorganisms present at corrosion sites. Most of the developed methods are based on the detection, quantification, and in some cases identification of specific microorganisms present at corrosion sites. However, as already highlighted, the presence of microorganisms does not necessarily correlate with active MIC. There is no single method that can be used to diagnose and confirm MIC reliably. In recent years, MMMs have received increased attention since they allow for the direct analysis of samples without the biases introduced by batch culturing microorganisms in the laboratory.

In view of the foregoing there is a need for faster, more reliable and more broadly applicable methods for MIC identification and monitoring in the field that may enable informed decision making on MIC mitigation as well as confirm the effectiveness of an implemented MIC mitigation program in the field.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY

The present disclosure is related to a novel approach to diagnose, monitor and mitigate microbiologically influenced corrosion (MIC) of infrastructures (e.g. pipelines and storage tanks) in the petroleum and natural gas industries based on the identification and quantification of biological signatures associated with active MIC. In some embodiments data is generated from the analysis of liquid or solid oil field samples which enables oil field operators to choose optimal mitigation measures to control MIC. This approach may be applied broadly in areas where MIC management is required for asset integrity in the petroleum and natural gas industry.

Current MIC identification and monitoring techniques (e.g. counting the total number of living cells, detection of sulfate-reducing bacteria, microbial community analysis based on DNA sequencing) are expensive, slow in turnaround of data and, most importantly, lack the ability to detect and diagnose MIC as stand-alone technologies. False conclusions may be made based on these techniques since the presence of broad groups of bacteria does not necessarily mean that corrosion-inducing metabolism is occurring, and for MIC there is no established correlation between any of the data generated by these techniques and the magnitude of MIC. By identifying and utilizing specific biological signatures associated with the corrosive physiology and metabolism of microorganisms, the present disclosure may provide a fast, reliable and widely applicable approach for MIC identification, monitoring and mitigation in the field.

The present disclosure may provide a simple and fast measurement of the types, patterns and abundance of biological signatures (‘biomarkers’) associated with MIC from field samples (e.g. pigging debris, biofilm from the surface of steel, and produced water or oil/water mixtures) and may be conducted at a relatively low cost and with higher accuracy, thus enabling faster decision making or adjustment of MIC management practices (e.g., biocide injection, pigging frequency, etc.) in the field.

In one aspect the present disclosure provides a method for diagnosing one or more types of microbiologically induced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC.

In another aspect the present disclosure provides a method for monitoring one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) repeating steps (a) and (b) at periodic intervals.

In another aspect the present disclosure provides a method for mitigating one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) implementing a MIC mitigation strategy at the site of interest based on the nature and concentration of the one or more biological signatures.

In any one of the herein disclosed aspects the one or more biological signatures are compared to one or more biological signatures in a reference database. The reference database may comprise information on the nature, pattern and/or concentration of biological signatures correlated to the extent of microbiologically induced corrosion. Accordingly, comparison of the nature, pattern and/or concentration of the one or more biological signatures at, or in close proximity to, the site of interest, or in one or more samples collected at, or in close proximity to, the site of interest, provides direct information on the type and extent of MIC. Using this information, appropriate action to counter the MIC may be implemented.

In any one of the herein disclosed aspects the biological signatures may be one or more of chemical species produced through the metabolism of microorganisms.

In any one of the herein disclosed aspects the biological signatures are selected from the group consisting of proteins, nucleic acids, lipids, metabolites, degradation products thereof, and mixtures thereof.

In any one of the herein disclosed aspects the site of interest may be the surface of equipment used for transporting, processing or storing oil and gas. Alternatively, the site of interest may be comprised in a laboratory test or experiment. The site of interest may be comprised in a control experiment.

In some embodiments the herein disclosed methods further comprise the step of collecting one or more samples from, or in close proximity to, the site of interest. As such, the nature and concentration of the one or more biological signatures may be determined from measurements on the one or more samples.

In other embodiments the nature and concentration of the one or more biological signatures may be determined via in situ measurements. For example, directly at, or in close proximity to, the site of interest.

In some embodiments the herein disclosed methods further comprise the step of extracting one or more extracellular and/or intracellular biological signatures from the one or more samples.

In any one of the herein disclosed methods the one or more samples may be oil or natural gas field samples. Preferably, the samples are selected from the group consisting of oil, gas, water, pigging debris, biofilm and mixtures thereof.

Alternatively, the samples may be produced as a result of a laboratory test or experiment.

In some embodiments the one or more samples are preserved prior to extraction. Alternatively, or additionally, the extracted one or more extracellular and/or intracellular biological signatures may be preserved prior to analysis.

Preferably preservation comprises treatment of the one or more samples, or the one or more extracted intracellular and/or extracellular biological signatures, with a chemical or chemicals, for example alcohol, acid, base or buffer. Alternatively, or additionally, the one or more samples or the one or more extracted intracellular and/or extracellular biological signatures may be preserved through storage at low temperature, for example at 0° C. or below.

Preservation may be performed in the field or, alternatively, in the laboratory.

In some embodiments the steps of determining and correlating, in any one of the herein disclosed methods, may be periodically repeated to monitor the ongoing degree of MIC and/or determine the effectiveness of an implemented MIC mitigation strategy. The steps may be repeated at intervals from between about once per day to about once per six months. Shorter or longer intervals are also contemplated.

In some embodiments the MIC mitigation strategy comprises one or more of, increasing or decreasing biocide usage, implementing a different biocide agent or agent(s), increasing or decreasing pigging frequency, changing pig type, for example to a more or less aggressive pig, and/or increasing or decreasing flow in a multiphase system.

The present disclosure also provides a method for constructing a database, said database comprising information on the nature and concentration of one or more biological signatures correlated with one or more types of MIC, the method comprising the steps of:
(a) determining the nature and/or concentration of one or more biological signatures at, or in close proximity to, a site of interest;
(b) determining one or more types of MIC at the site of interest;
(c) correlating the nature and/or concentration of the one or more biological signatures with the one or more types of MIC; and
(d) constructing a database comprising information correlating the nature and/or concentration of one or more biological signatures with one or more types of MIC.

The present disclosure also provides a database, said database comprising information on the nature and/or concentration of one or biological signatures correlated with one or more types of MIC.

Advantages of the methods disclosed herein may include one or more of the following:
Particular biological signatures are determinative of particular microorganism activity and, through the use of a reference database, may be directly linked to MIC.
Mitigating treatments may be specifically targeted to particular MIC type.
Methods are fast and reliable.
Cost savings may result as unnecessary mitigation treatments can be avoided.

Further features and advantages of the present disclosure will be understood by reference to the following drawings and detailed description.

### BRIEF DESCRIPTION OF THE DRAWINGS

FIG. 1 is a drawing of a steel surface exposed to water and comprising a corrosive biofilm. Potential biological signatures associated with MIC are present in the biofilm and in the water.

FIG. 2 is a flowchart of a method according to one embodiment of the present disclosure.

FIG. 3 is flowchart of a method according to another embodiment of the present disclosure.

### DETAILED DESCRIPTION

Microbiologically Influenced Corrosion (‘MIC’) is frequently observed at oil production sites and in transport pipelines, among other types of equipment involved in the oil and gas production industry. MIC poses severe operational, environmental, and safety problems to the petroleum and/or natural gas industries, particularly with respect to corrosion of equipment used in the storage, processing, and/or transport of oil and gas, crude and/or processed materials. Costs resulting from MIC in these industries due to repair and replacement of damaged equipment, spoiled oil, and lost production due to corrosion-related facility shut-down amount to well over several billion USD per year. Biofilms that form on the surfaces of such metal components are thought to be the primary causative agent triggering such corrosion as many biofilm-forming environmental bacteria—particularly those in anaerobic environments—produce harmful gases (e.g., hydrogen sulfide), acids (e.g., organic acids), and other agents which are highly corrosive, in addition to directly affecting materials integrity. Current mitigation techniques to reduce MIC are available, but are not effective enough and/or are not practical in the industry due to high cost and because conditions that lead to MIC formation are not well understood or predictable based on current knowledge.

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any methods and materials similar or equivalent to those described herein can also be used in the practice or testing of the present disclosure, the preferred methods and materials are now described.

It must also be noted that, as used in the specification and the appended claims, the singular forms ‘a’, ‘an’ and ‘the’ include plural referents unless otherwise specified. Thus, for example, reference to ‘biological signature’ may include more than one biological signatures, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless defined otherwise, all technical and scientific terms used herein have the meaning commonly understood by a person skilled in the art to which this disclosure belongs. The following references, the entire disclosures of which are incorporated herein by reference, provide one of skill with a general definition of many of the terms (unless defined otherwise herein) used in this disclosure: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, the Harper Collins Dictionary of Biology (1991). Generally, the procedures of molecular biology methods described or inherent herein and the like are common methods used in the art. Such standard techniques can be found in reference manuals such as for example Sambrook et al., (2000, Molecular Cloning—A Laboratory Manual, Third Edition, Cold Spring Harbor Laboratories); Ausubel et al., (1994, Current Protocols in Molecular Biology, John Wiley & Sons, New-York); and Methods in Molecular Biology, Volume 733, 2011, High-Throughput Next Generation

Sequencing, Methods and Applications Ed. Y. M. Kwon and S. C. Ricke, Springe.

The following terms may have meanings ascribed to them below, unless specified otherwise. However, it should be understood that other meanings that are known or understood by those having ordinary skill in the art are also possible, and within the scope of the present disclosure. In the case of conflict, the present disclosure, including definitions, will control. In addition, the materials, methods, and examples are illustrative only and not intended to be limiting.

As used herein, the term ‘biocide’ refers to a chemical or biological substance which can deter, render harmless, or exert a controlling effect on any harmful organism by chemical or biological means. Biocides include those that are synthetic, but also those which are naturally obtained, e.g., obtained or derived from bacteria and plants. Biocides can include, but are not limited to, germicides, antibiotics, antibacterials, antivirals, antifungals, antiprotozoals and antiparasites, or combinations thereof. Such compounds are well-known in the art and may be obtained easily from commercial sources. Reference may be made to the biocides disclosed in the book Corrosion in the Petrochemical Industry, Ed. Linda Garverick, ASM International, 1994, the contents of which are incorporated herein by reference.

As used herein, the term ‘Microbiologically Influenced Corrosion’ or ‘MIC’ or similar terms are terms in the art and shall be understood according to the meaning ascribed in the field, i.e., corrosion to metal surfaces caused directly or indirectly through the effects of bacteria and their by-products and metabolites at metal surfaces, including especially bacteria that grow on the surface of metal in a biofilm. MIC can occur in both aerobic and anaerobic conditions and generally is thought to require the presence of bacteria in a biofilm. MIC is considered ‘biotic corrosion’. MIC is often associated with surface pitting, which leads to more rapid corrosive failure than uniform corrosion.

As used herein, the term ‘sulfate-reducing bacteria’ or ‘SRB’, which are considered one of the main culprits of biotic corrosion in anaerobic conditions, are a group of bacteria that includes at least 220 species which produce H₂S, and use sulfates as the terminal electron acceptor. Many SRB are considered obligate anaerobes, meaning that the cells cannot metabolize and/or replicate in the presence of oxygen, although many species can temporarily tolerate low levels of oxygen. Furthermore, anaerobic conditions capable of supporting SRB growth can be created in overall aerobic environments, due to the microniches created within the bacterial biofilm/corrosion product layer. Although SRB are the most studied and well understood of the anaerobic corrosion inducing bacteria, MIC can occur in anaerobic conditions in the absence of SRB.

As used herein, the terms ‘biological signature’ or ‘biomarker’ refer to chemical species that are produced by the metabolism of microorganisms. Biological signatures include, but are not limited to, metabolites, lipids, proteins, nucleic acids and their degradation products.

As used herein, the term ‘omics’ refers to a field of study in biology such as genomics, lipidomics, proteomics, metabolomics, and transcriptomics. Omics aims at the collective characterization and quantification of pools of biological molecules that translate into the structure, function, and dynamics of an organism or organisms.

As used herein, the term ‘pigging’ refers to the well-known process of intentional mechanical delamination of corrosion products and biofilm material from the surfaces of metals.

As used herein, the term ‘corrosion’ refers to the general deterioration of a material (e.g., metallic material) due to its reaction with the environment.

Unless specifically stated or obvious from context, as used herein, the term “about” is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any methods provided herein can be combined with one or more of any of the other methods provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims. Biological signatures for MIC monitoring and identification.

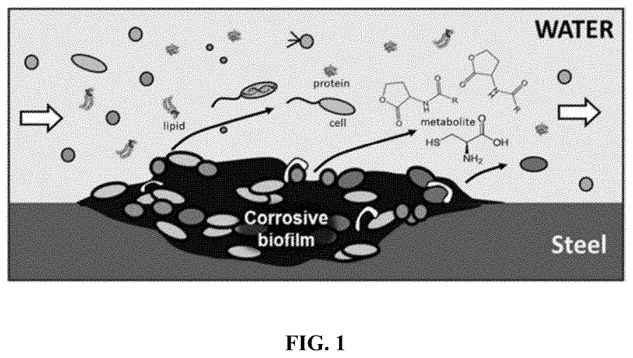

MIC occurs when microorganisms attach to the inner wall of pipelines or other ferrous oil field infrastructure to form biofilms (see FIG. 1) and locally consume the metal either directly or as a collateral effect of corrosive metabolic by-products (e.g., hydrogen sulfide and/or carbonic acid). To form a biofilm on the metal surface, microorganisms need to communicate among one another using quorum sensing signals (small chemical molecules that are a class of metabolites made by living organisms) and adjust their physiology and metabolism to build up the biofilm on the metal surface. Many microorganisms that are involved in MIC can additionally take up electrons from steel through membrane-associated redox proteins via extracellular electron transfer mediators (such as proteins and extracellular polymeric substances (EPS)). Furthermore, certain types of microbial metabolism can lead to a degradation of the metallic substratum on which the biofilm develops. The rationale of using biological signatures such as metabolites, lipids, proteins,

DNA and RNA, or their degradation products, from either intracellular or extracellular sources for MIC identification and monitoring lies in the fact that corrosive microorganisms undergo different metabolisms and leave unique signatures in the surrounding environment (e.g. produced waters and pigging debris) compared to non-corrosive microorganisms. By establishing the relationship between the type and relative abundance and/or pattern of biological signatures with the type and severity of MIC, a culture-independent and reliable MIC identification and monitoring approach can be developed. Such identification and monitoring is the basis for improved MIC mitigation with validated effectiveness.

The MIC mitigation methods disclosed herein can be used to treat any affected surface, and, in particular, any affected metal surface on any equipment involved in the storage, transport, and/or refinery of petroleum and/or natural gas products. For example, affected surfaces can include pipeline that transports crude oil from onshore or offshore production site to local or distant petroleum and/or natural gas refineries. Problematic biofilms can form along the interior surfaces of pipelines over distances that extend over many miles or tens of miles, leading to corrosive conditions over a multitude of points. It is generally accepted that pipeline corrosion represents the majority of corrosive damage due to MIC in the oil and gas industries, particularly given that there are over 190,000 miles of liquid pipelines in the US alone. In another example, affected surfaces can include oil storage facilities at refinery sites or those located on oil transport tankers. Other equipment, such as pumps, valves, and other equipment that encounters the oil flow path is susceptible to the formation of biofilms and thus to MIC. Any and all of these sites and surfaces may be monitored and/or treated using the methods disclosed herein.

### MIC Mitigation

The disclosure relates to the findings that certain correlations exist between the nature and concentration of biological signatures present in liquid samples and/or solid samples from oil and gas infrastructures and the nature and/or degree of MIC. Based on these findings, the inventors have devised methods for conditionally treating MIC by evaluating whether MIC-correlating conditions exist, based on the nature and concentration of one or more biological signatures, the nature and/or degree of MIC, if present, and then applying concomitant MIC-mitigating treatment scheme which is adjusted in its degree of aggressiveness in proportion to MIC severity. The correlation between the presence of certain biological signatures and degree of MIC is facilitated by a reference database that contains historical information linking the nature and concentration of biological signatures with MIC severity. In other words, when one or more particular biological signatures are detected at, or in close proximity to, a site of interest or in a sample obtained from, or in close proximity to, a site of interest this is indicative of the presence of MIC and appropriate action may be taken. Conversely, if the biological signatures detected at, or in close proximity to, a particular site of interest or in a sample obtained from, or in close proximity to, the site of interest are not associated with MIC, no particular mitigating action need be taken, or if such action is already in place, it may be terminated or reduced. The disclosed methodology allows, in part, for the continuous monitoring and assessment of MIC risk in petroleum-based equipment (e.g., pipeline) and the administering of a treatment that corresponds to the level of severity of the MIC. The methodology also provides for continuous or periodic assessment to evaluate the effectiveness of said treatments, and whether reductions and/or increases in the aggressiveness of the treatment are required. The methods described herein provide for selective MIC management which in turn results in more effective and targeted solutions with significant costs savings.

As a result of the herein methods, a mitigation treatment is administered for mitigating or eliminating MIC of a metal surface. In certain embodiments, the treatment can comprise contacting a metal surface with an effective amount of a liquid composition comprising a MIC mitigating substance (e.g., a biocide). In another aspect, the disclosure relates to a method for reducing or preventing the formation or activity of a corrosion-associated biofilm on a metal surface comprising contacting the metal surface with an effective amount of a liquid composition comprising a MIC mitigating substance (e.g., a biocide).

The methods disclosed herein may also include testing frameworks that facilitate knowing whether and how to administer a MIC mitigation treatment. Such treating frameworks may aim to determine whether a target system has a legitimate MIC risk at a particular site of interest (e.g., crude pipeline that transports crude oil from an offshore rig to an onshore processing facility). Other steps may also involve subsequent monitoring steps to evaluate the extent of the MIC, and followed then by steps to carry out a particular treatment plan, e.g., an aggressive treatment plan or a lower-strength treatment plan, or to adjust existing plans to either increase or decrease a treatment program based on the whether a certain initial treatment is effective.

For example, corrosive damage to a pipeline might be detected as a result of regularly scheduled maintenance along a certain ten-mile stretch of crude oil pipeline. In order to learn more about the extent and nature of the damage, and therefore, determine an appropriate treatment, a user might sample the environmental conditions at various points along the pipeline and determine the nature and concentration of biological signatures. The results may then be compared to an information database that indicates which biological signatures are reflective of MIC. The results can be evaluated and then assessed by the skilled person to design a specifically tailored MIC mitigation treatment.

Treatment may be aggressive in nature, or otherwise less aggressive, depending on the degree and severity of the MIC determined, based on the nature and concentration of the biological signatures. For example, if the biological signatures indicate that MIC is low, a gentle treatment may be administered by, for example, reducing the total amount or concentration of MIC mitigation substance delivered, reducing the number of hours of continued injection into the site of interest, or increasing the number of days spanning between follow-up injections. However, if the biological signatures indicate that MIC is high, a more aggressive treatment may be administered by, for example, increasing the total amount or concentration of MIC mitigation substance delivered, increasing the time period for continuous injection, increasing the frequency of administration, or shortening the number of time or days between successive treatments.

The present disclosure provides a method for diagnosing one or more types of microbiologically induced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC.

The present disclosure also provides a method for monitoring one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) repeating steps (a) and (b) at periodic intervals.

The present disclosure further provides a method for mitigating one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) implementing a MIC mitigation strategy at the site of interest based on the nature and concentration of the one or more biological signatures.

In any one of the methods the biological signatures may be one or more of chemical species produced through the metabolism of microorganisms.

In any one of the methods the biological signatures are selected from the group consisting of proteins, nucleic acids, lipids, metabolites, degradation products thereof, and mixtures thereof.

In any one of the methods the site of interest may be the surface of equipment used for transporting, processing or storing oil and gas, for example, a pipeline, a mixing vessel or a storage vessel.

In some embodiments the methods further comprise the step of collecting one or more samples from, or in close proximity to, the site of interest. As such, the nature and concentration of the one or more biological signatures may be determined from measurements on the one or more samples.

In other embodiments the nature and concentration of the one or more biological signatures may be determined via in situ measurements. For example, directly at, or in close proximity to, the site of interest.

In some embodiments the herein disclosed methods further comprise the step of extracting one or more extracellular and/or intracellular biological signatures from the one or more samples.

In any one of the herein disclosed methods the one or more samples may be oil or natural gas field samples. Preferably, the samples are selected from the group consisting of oil, gas, water, pigging debris, biofilm and mixtures thereof.

In some embodiments the one or more samples are preserved prior to extraction. Alternatively, or additionally, the extracted one or more extracellular and/or intracellular biological signatures may be preserved prior to analysis.

Preferably preservation comprises treatment of the one or more samples, or the one or more extracted intracellular and/or extracellular biological signatures, with a chemical or chemicals, for example alcohol, acid, base or buffer. Alternatively, or additionally, the one or more samples or the one or more extracted intracellular and/or extracellular biological signatures may be preserved through storage at low temperature.

In some embodiments preservation may be at below ambient temperature, for example, below 20° C., or below 10° C., or below 0° C. or below -10° C.

Preservation may be performed in the field or, alternatively, in the laboratory.

Preservation may assist in maintaining the nature and concentration of biological signatures between sampling and analysis.

In any one of the herein disclosed methods the at least one biological signature is compared to one or more biological signatures in a reference database. The reference database may comprise information on the nature, pattern and/or concentration of biological signatures correlated to the extent of microbiologically induced corrosion. Accordingly, comparison of the nature, pattern and/or concentration of the one or more biological signatures at, or in close proximity to, the site of interest, or in one or more samples collected at, or in close proximity to, the site of interest, provides direct information on the type and extent of MIC. Using this information, appropriate action to counter the MIC may be implemented.

In some embodiments the steps of determining and correlating, in any one of the herein disclosed methods, may be periodically repeated to monitor the ongoing degree of MIC and/or determine the effectiveness of an implemented MIC mitigation strategy. The steps may be repeated at intervals from between about once per day to about once per six months. Shorter or longer intervals are also contemplated.

In some embodiments the MIC mitigation strategy comprises one or more of, increasing or decreasing biocide usage, implementing a different biocide agent or agent(s), increasing or decreasing pigging frequency, changing pig type, for example to a more or less aggressive pig, and/or increasing or decreasing flow in a multiphase system.

The present disclosure also provides a method for constructing a database, said database comprising information on the nature and/or concentration of one or biological signatures arising from one or more types of MIC, the method comprising the steps of:
(a) determining the nature and/or concentration of one or more biological signatures at, or in close proximity to, a site of interest;
(b) determining one or more types of MIC at the site of interest;
(c) correlating the nature and/or concentration of the one or more biological signatures with the one or more types of MIC; and
(d) constructing a database comprising information correlating the nature and concentration of one or more biological signatures with one or more types of MIC. Example of a work flow chart for diagnosing biological signature(s) that are associated with

### MIC

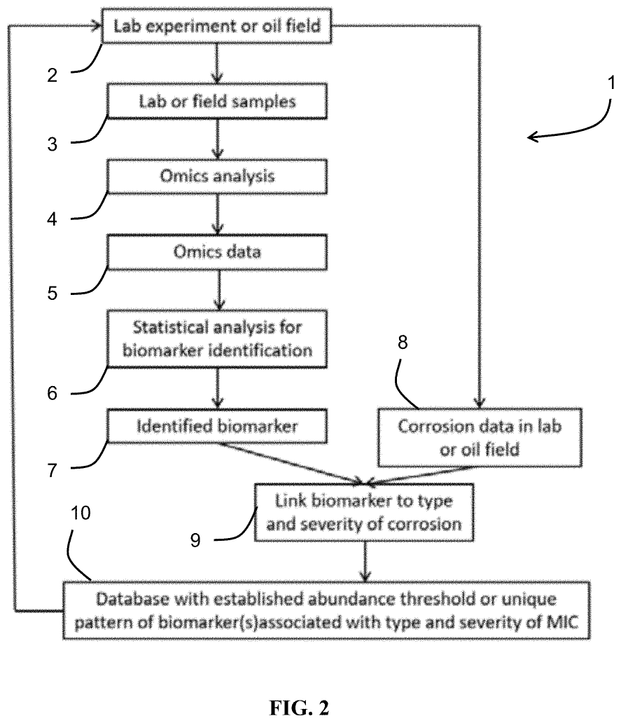

An example of a work flow chart for identifying biological signatures associated with MIC is shown in FIG. 2. Samples for this work flow may come from a site of interest which may be from laboratory experiments or from infrastructure in an oil or gas field such as crude oil pipelines or storage tanks with and/or without active MIC. Samples comprise liquid samples (e.g.

produced water or water and oil mixture) and/or solid samples (e.g. biofilm collected from corrosion coupons and pigging debris).

The ‘omics’ analyses comprise, but are not limited to, metabolomics, proteomics, transcriptomics and metagenomics analyses. Data obtained from such ‘omics’ analyses may be statistically interpreted to identify potential biological signatures, such as metabolites, lipids, proteins, DNA and RNA, and/or their degradation products. These identified biological signatures may be systematically correlated back to type and severity of active MIC by the change in abundance and/or change of pattern of a group of identified biological signatures with statistical significance. For different corrosive cultures and field conditions, these biological signatures associated with MIC may vary. The work flow can be repeated for the validation process of identified biological signature(s) and/or the improvement of the MIC prediction model by using identified biological signature(s).

Unlike prior art methods which rely on the detection and quantification of microorganisms present at corrosion sites for MIC diagnosis and monitoring, biological signatures associated with MIC are superior real-time indicators for active metabolism of microorganisms associated with corrosion, and thus can potentially provide a more reliable and efficient evaluation of MIC.

Referring to FIG. 2, work flow chart (1) is depicted. At step (2) a lab experiment or oil field experiment is selected, from which a lab or oil field sample (3) results. Omics analyses at step (4) produces omics data at step (5), which is subsequently statistically analysed for biological signature identification at step (6), yielding identified biological signatures at step (7). In a separate work flow, the lab experiment or oil field experiment at (2) results in corresponding corrosion data at step (8). Subsequently, the identified biological signatures are linked to the type and severity of corrosion to yield database (10). The database contains the established abundance threshold or unique pattern of biological signatures(s) associated with type and severity of MIC. Example of a work flow chart for identification, monitoring and mitigation of MIC

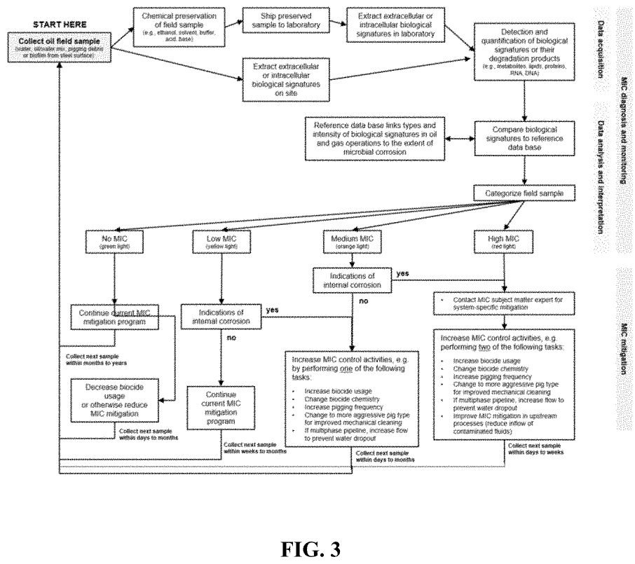

FIG. 3 illustrates a framework for MIC identification (diagnosis) and monitoring in oil pipelines and storage tanks by using biological signatures including metabolites, lipids, proteins, DNA and RNA, or their degradation products. Data from this monitoring technique may in certain cases be interpreted in conjunction with other microbiological information, chemical and physical data, operational data and corrosion data for a more robust MIC diagnosis.

The framework is divided into two sections, namely ‘MIC diagnosis and monitoring’ and ‘MIC mitigation’. ‘MIC diagnosis and monitoring’ is further divided into two phases, namely ‘data acquisition’ and ‘data analysis and interpretation’.

Referring to FIG. 3, an oil field sample is collected. The sample may be, for example, water, an oil/water mixture, pigging debris or biofilm from a steel surface. The sample may be subjected to treatment in the field to extract extracellular and/or intracellular biological signatures. Alternatively, the sample may be subjected to preservation (chemical treatment and/or low temperature storage) and extraction performed later, for example, after shipment to a laboratory.

The extract is analyzed to determine the nature and concentration of biological signatures and/or their degradation products. The results are compared to biological signatures in a reference database which contains data linking particular biological signatures with the nature and/or extent of MIC. Based on the comparison the field sample may then be categorized.

In certain embodiments the field sample is categorized as ‘high MIC’, ‘medium MIC’, ‘low MIC’ or ‘no MIC’. Based on the category, a suitable MIC mitigation treatment may be implemented.

The determined nature and/or severity of MIC enables an informed decision on how to adjust MIC mitigation measures.

In certain embodiments, the ‘high MIC’ category may necessitate an increase in MIC control activities by, for example, performing two of the following: increasing biocide usage, changing biocide chemistry, increasing pigging frequency, changing to a more aggressive pig type, increasing flow if the system is a multiphase pipeline or improving MIC mitigation in upstream processes.

Further, ‘high MIC’ designation is associated with a relatively short frequency of repeat sampling, for example, in the order of days to weeks.

In certain embodiments, the ‘medium MIC’ category may necessitate an increase in MIC control activities by, for example, performing one of the following: increasing biocide usage, changing biocide chemistry, increasing pigging frequency, changing to a more aggressive pig type, or increasing flow if the system is a multiphase pipeline.

Further, ‘medium MIC’ designation is associated with a relatively intermediate frequency of repeat sampling, for example, in the order of days to months.

In certain embodiments, the ‘low MIC’ category may indicate that no change is required to the current MIC mitigation program.

Further, low MIC' designation is associated with a relatively long frequency of repeat sampling, for example, in the order of weeks to months.

In certain embodiments, the ‘no MIC’ category may indicate that no change is required to the current MIC mitigation program.

Further, ‘no MIC’ designation is associated with a relatively long frequency of repeat sampling, for example, in the order of days to months.

The iterative nature of the above described approaches enables the validation of mitigation effectiveness as well as optimization of the MIC mitigation program.

In still other embodiments, the biocides used in the disclosed treatments may be selected from the group consisting of germicides, antibiotics, antibacterials, antivirals, antifungals, antiprotozoals and antiparasites, or combinations thereof.

In various embodiments, an amount of a liquid composition comprising the disclosed biocides provides a concentration of the biocide that is between about 50-500 micromolar, about 0.5-1.0 mM, about 1.0 mM-5 mM, about 2.5 mM-10 mM, about 5 mM-25 mM, about 10 mM-100 mM, or about 50 mM-1000 mM. As the disclosed monitoring frameworks are implemented, these levels may be adjusted as the severity of MIC changes through the course of treatment.

In various other embodiments, the effective amount of the liquid composition comprising the disclosed biocides provides a final in situ concentration of the biocide at the site of interest (i.e., which takes into account the flow rate and volume of target solution in order to achieve a final concentration) that is between about 0.1 ppm to 1 ppm, or about 1 ppm to 5 ppm, or about 2.5 ppm to 10 ppm, or about 5 ppm to 20 ppm, or about 10 ppm to 40 ppm, or about 20 ppm to 100 ppm, or about 40 ppm to 500 ppm, or about 100 ppm to 1000 ppm, or about 500 ppm to 10,000 ppm, or more. As the disclosed monitoring frameworks are implemented, these levels may be adjusted as the severity of MIC changes through the course of treatment.

Examples of suitable biocides may include both so-called non-oxidizing and oxidizing biocides. Examples of commonly available oxidizing biocides include hypochlorite bleach, such as calcium hypochlorite and lithium hypochlorite, peracetic acid, potassium monopersulfate, potassium peroxymonosulfate, bromochlorodimethylhydantoin, dichloroethylmethylhydantoin, chloroisocyanurate, trichloroisocyanuric acids and dichloroisocyanuric acids and salts thereof, or chlorinated hydantoins. Suitable oxidizing biocides may also include, for example bromine products such as stabilized sodium hypobromite, activated sodium bromide, or brominated hydantoins. Suitable oxidizing biocides may also include, for example chlorine dioxide, ozone, inorganic persulfates such as ammonium persulfate, or peroxides, such as hydrogen peroxide and organic peroxides.

Examples of non-oxidizing biocides include quaternary ammonium salts, aldehydes and quaternary phosphonium salts.

Examples of aldehydes include formaldehyde, glyoxal, furfural, acrolein, methacrolein, propionaldehyde, acetaldehyde, crotonaldehyde and mixtures thereof. Examples of quaternary ammonium salts include pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, methylbenzethonium chloride, myristyl-gamma-picolinium chloride, ortaphonium chloride, triclobisonium chloride, alkyl dimethyl benzyl ammonium chloride, cocodiamine, and mixtures thereof.

Examples of phosphonium salts include, for example, tributyltetradecyl phosphonium chloride.

Other examples of commonly available non-oxidizing biocides may include dibromonitfilopropionamide, thiocyanomethylthiobenzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl)phosphonium sulfate, glutaraldehyde, alkyldimethylbenzyl ammonium chloride, didecyldimethylammonium chloride, poly [oxyethylene-(dimethyliminio)ethylene(dimethyliminio)ethylene dichloride], decylthioethanamine, and terbuthylazine.

Other examples of non-oxidizing biocides may include isothiazolinone biocides such as, for example, 5-chloro-2-methyl-4-isothiazolin-3-one, 2-methyl-4-isothiazolin-3-one, and 1,2-benzisothiazolin-3-one and combinations thereof.

Additional examples of non-oxidizing biocides may include, for example, 2-bromo-2-nitro-1,3-propanediol, 2-2-dibromo-3-nitrilopropionamide, tris(hydroxymethyl)nitromethane, 5-bromo-5-nitro-1,3-dioxane and sulfur compounds, such as, for example, isothiazolone, carbamates, and metronidazole.

Additional examples of oxidizing and non-oxidizing biocides include triazines such as 1,3,5-tris-(2-hydroxyethyl)-s-triazine and trimethyl-1,3, 5-triazine-1,3, 5-triethanol.

### Combination Treatments

The disclosed treatment methods are also contemplated to be combined with other MIC-mitigation strategies, such as the use of corrosion-resistant metals, temperature control, pH control, radiation, filtration, protective coatings, the use of corrosion inhibitors or other chemical controls (e.g., biocides, oxidizers, acids, alkalis), bacteriological controls (e.g., phages, enzymes, parasitic bacteria, antibodies, competitive microflora), pigging (i.e., mechanical delamination of corrosion products), anodic and cathodic protection, and modulation of nutrient levels.

In particular, in certain embodiments relating to pipeline treatment, the pipeline is first treated with pigging. The pigging can help not only to physically remove MIC-causing biofilms, but also acts to disturb the biofilm such that the permeation of the biofilm is improved, thereby rendering the biocide treatments more effective.

Methods and equipment for pigging lines is well known in the art, and can be found described in the following US patents, each of which are incorporated by reference: U.S. Pat. Nos. 9,010,826; 8,858,732; 8,719,989; 7,739,767; 7,275,564; 6,874,757; 6,182,761; and 6,109,829.

### Certain Embodiments

Certain embodiments of methods according to the present disclosure are presented in the following paragraphs.

Embodiment 1 provides a method for diagnosing one or more types of microbiologically induced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with the one or more types of MIC.

Embodiment 2 provides a a method for monitoring one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with the one or more types of MIC; and
(c) repeating steps (a) and (b) at periodic intervals.

Embodiment 3 provides a method for mitigating one or more types of microbiologically
influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) implementing a MIC mitigation strategy at the site of interest based on the nature and/or concentration of the one or more biological signatures.

Embodiment 4 provides a method for constructing a database, said database comprising information on the nature and concentration of one or more biological signatures correlated with one or more types of MIC, the method comprising the steps of:
(a) determining the nature and/or concentration of one or more biological signatures at, or in close proximity to, a site of interest;
(b) determining one or more types of MIC at the site of interest;
(c) correlating the nature and/or concentration of the one or more biological signatures with the one or more types of MIC; and
(d) constructing a database comprising information correlating the nature and/or concentration of one or more biological signatures with one or more types of MIC.

Embodiment 5 provides a database, said database comprising information on the nature and/or concentration of one or biological signatures correlated with one or more types of MIC.

Embodiment 6 provides a method according to any one of embodiments 1 to 4, wherein
the correlation comprises comparing the one or more determined biological signatures with one or more biological signatures in a reference database, said reference database linking the nature and concentration of the determined biological signatures to one or more types of MIC.

Embodiment 7 provides a method according to any one of embodiments 1 to 4, wherein the method further comprises the step of collecting one or more samples at, or in close proximity to, the site of interest, and performing the determination of step (a) on the one or more samples.

Embodiment 8 provides a method according to embodiment 7, wherein the method further comprises the step of extracting one or more extracellular and/or intracellular biological signatures from the one or more samples.

Embodiment 9 provides a method according to any one of embodiments 1 to 5, wherein the biological signatures are selected from the group consisting of proteins, nucleic acids, lipids, metabolites, degradation products thereof, and mixtures thereof.

Embodiment 10 provides a method according to embodiment 7, wherein the one or more samples are oil field samples.

Embodiment 11 provides a method according to embodiment 10, wherein the oil field samples are selected from the group consisting of oil, water, pigging debris, biofilm and mixtures thereof.

Embodiment 12 provides a method according to embodiment 7, wherein the one or more samples are preserved.

Embodiment 13 provides a method according to embodiment 12, wherein preservation comprises chemically treating the one or more samples with, for example, alcohol, acid, base or buffer and/or comprises cooling the one or more samples below ambient temperature.

Embodiment 14 provides a method according to embodiment 13, wherein preservation is performed in the field.

Embodiment 15 provides a method according to embodiment 8, wherein extraction is performed in the field or in a laboratory.

Embodiment 16 provides a method according to any one of embodiments 1 to 4 or 6 to 15, wherein the site of interest is selected from the group consisting of a surface of equipment used for transporting, processing and storing oil or gas.

Embodiment 17 provides a method according to any one of embodiments 1 to 4 or 6 to 15, wherein the site of interest is comprised in a control experiment.

Embodiment 18 provides a method according to any one of embodiments 3 or 6 to 17, wherein the MIC mitigation strategy comprises one or more of, increasing or decreasing biocide usage, implementing a different biocide agent or agent(s), increasing or decreasing pigging frequency, changing pig type, for example to a more or less aggressive pig, and/or increasing or decreasing flow in a multiphase system.

The contents of all references, including any publicly available polypeptide and/or nucleic acid sequences accession numbers (e.g., GenBank), and published patents and patent applications cited throughout the application are hereby incorporated by reference. Those skilled in the art will recognize that the disclosure may be practiced with variations on the disclosed structures, materials, compositions and methods, and such variations are regarded as within the ambit of the disclosure.

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

1. A method for diagnosing or monitoring one or more types of microbiologically induced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with the one or more types of MIC.

2. A method according to claim 1, wherein the correlation comprises comparing the one or more determined biological signatures with one or more biological signatures in a reference database, said reference database linking the nature and concentration of the determined biological signatures to one or more types of MIC.

3. A method according to claim 1, wherein the method further comprises the step of collecting one or more samples at, or in close proximity to, the site of interest, and performing the determination of step (a) on the one or more samples.

4. A method according to claim 3, wherein the method further comprises the step of extracting one or more extracellular and/or intracellular biological signatures from the one or more samples.

5. A method according to claim 1, wherein the biological signatures are selected from the group consisting of proteins, nucleic acids, lipids, metabolites, degradation products thereof, and mixtures thereof.

6. A method according to claim 3, wherein the one or more samples are oil field samples.

7. A method according to claim 3, wherein the one or more samples are selected from the group consisting of oil, water, pigging debris, biofilm and mixtures thereof

8. A method according to claim 3, wherein the one or more samples are preserved.

9. A method according to claim 3, wherein the one or more samples are preserved and the preservation comprises chemically treating the one or more samples with, for example, alcohol, acid, base or buffer and/or comprises cooling the one or more samples below ambient temperature.

10. A method according to claim 3, wherein the one or more samples are preserved and the preservation is performed in the field.

11. A method according to claim 4, wherein extraction is performed in the field or in a laboratory.

12. A method according to claim 1, wherein the site of interest is selected from the group consisting of a surface of equipment used for transporting, processing and storing oil or gas.

13. A method according to claim 1, wherein the site of interest is comprised in a control experiment.

14. A method according to claim 1, wherein steps (a) and (b) are repeated at periodic intervals.

15. A method for mitigating one or more types of microbiologically influenced corrosion (MIC) at a site of interest comprising the steps of:
(a) determining the nature and/or concentration of one or more biological signatures at, or in close proximity to, the site of interest;
(b) correlating the nature and/or concentration of the one or more biological signatures with one or more types of MIC; and
(c) implementing a MIC mitigation strategy at the site of interest based on the nature and/or concentration of the one or more biological signatures.

16. A method according to claim 15, wherein the correlation is performed by comparing the one or more determined biological signatures with one or more biological signatures in a reference database, said reference database linking the nature and concentration of the determined biological signatures to one or more types of MIC.

17. A method according to claim 15, wherein the method further comprises the step of collecting one or more samples at, or in close proximity to, the site of interest, and performing the determination of step (a) on the one or more samples.

18. A method according to claim 17, wherein the method further comprises the step of extracting one or more extracellular and/or intracellular biological signatures from the one or more samples.

19. A method according to claim 18, wherein the biological signatures are selected from the group consisting of proteins, nucleic acids, lipids, metabolites, degradation products thereof, and mixtures thereof.

20. A method according to claim 17, wherein the one or more samples are oil field samples.

21. A method according to claim 17, wherein the one or more samples are selected from the group consisting of oil, water, pigging debris, biofilm and mixtures thereof

22. A method according to claim 17, wherein the one or more samples are preserved.

23. A method according to claim 17, wherein the one or more samples are preserved and the preservation comprises chemically treating the one or more samples with, for example, alcohol, acid, base or buffer and/or comprises cooling the one or more samples below ambient temperature.

24. A method according to claim 17, wherein the one or more samples are preserved and the preservation is performed in the field.

25. A method according to claim 18, wherein extraction is performed in the field or in a laboratory.

26. A method according to claim 15, wherein steps (a) to (c) are periodically repeated.

27. A method according to claim 15, wherein the site of interest is selected from the group consisting of a surface of equipment used for transporting, processing and storing oil or gas.

28. A method according to claim 15, wherein the site of interest is comprised in a control experiment.

29. A method according to claim 15, wherein the MIC mitigation strategy comprises one or more of, increasing or decreasing biocide usage, implementing a different biocide agent or agent(s), increasing or decreasing pigging frequency, changing pig type, for example to a more or less aggressive pig, and/or increasing or decreasing flow in a multiphase system.
